(19) United States
(12) Patent Application Publication
(10) Pub. No.: US 2006/0036441 A1
(43) Pub. Date: Feb. 16, 2006

(54) Data-managing apparatus and method

(75) Inventor: Makoto Hirota, Shibuya-ku (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/201,013

(22) Filed: Aug. 10, 2005

(30) Foreign Application Priority Data
Aug. 13, 2004 (JP) 2004-236070

(51) Int. Cl. G10L 21/00

(52) U.S. Cl. 704/270.1

(57) ABSTRACT

A data-managing method for managing image data is provided. The method includes receiving the data and corresponding linked voice data, recognizing the voice data with voice-recognition processings to obtain voice recognition results, and then storing the data and the voice-recognition results in a linked manner.

### BACKGROUND OF THE INVENTION

1. Field of the Invention

The present invention relates to a data-managing apparatus and method for adding voice information to data so that the voice information serves as an identifier for searching for the data.

2. Description of the Related Art

There has been a growing use of digital information in a variety of multimedia. Text data and a variety of digital data such as still pictures and moving pictures are stored in information equipment. Hence, techniques for effectively searching for these kinds of digital data have become more important. For example, along with the popularization of digital cameras, digital data of captured pictures taken by cameras is increasingly taken by and stored in a personal computer (PC). Accordingly, there is a need for a technique for searching for a specific picture among stored ones.

In the meantime, an increasing number of digital cameras have a function of adding voice information, serving as a voice annotation, to respective captured pictures. For example, Japanese Patent Laid-Open No. 2003-219327 (corresponding to U.S. patent application No. 2003/063321) discloses a method for searching for a desired picture with the aid of voice information serving as an identifier. In the foregoing patent document, a voice annotation is converted into text data via a voice-recognition processing, and a keyword search is performed on the basis of this text data.

Unfortunately, the voice-recognition processing is generally affected by noise. For example, in the case of a digital camera, pictures are captured in a variety of environments such as an area in a house, a place where an operator is staying, and an exhibition hall. Hence, when voice sound is inputted at the corresponding site, the inputted voice sound is affected by the noise at the site. Also, other than noise, the inputted voice sound is likely affected by differences in gender and age of persons inputting the voice sound. In the known voice-annotation search technique disclosed by the foregoing patent document, the environment noise and the differences in gender and age of the voice-inputting person as described above are not always fully taken into account. As a result, the voice recognition feature deteriorates, thereby deteriorating search accuracy.

### SUMMARY OF THE INVENTION

The present invention is directed to a data-managing method and apparatus with which a more accurate search is achieved on the basis of voice recognition results by taking into account voice-inputting conditions (for example, a noise environment at the time of inputting a voice, and a gender and an age of a speaker) upon adding voice information to data.

In accordance with one aspect of the present invention, a data-managing method includes the steps of: receiving image data and corresponding linked voice data; recognizing the voice data with voice-recognition processings to obtain voice recognition results; and storing the image data and the voice recognition results in a mutually linked manner.

In accordance with another aspect of the present invention, a data-managing apparatus includes a receiving device configured to receive data, including image data and corresponding linked voice data; a voice recognition unit configured to apply voice-recognition processings on the voice data to obtain voice recognition results; and a storing device configured to store the data and the voice recognition results in a mutually linked manner.

Further features of the present invention will become apparent from the following description of exemplary embodiments with reference to the attached drawings.

### BRIEF DESCRIPTION OF THE DRAWINGS

FIG. 1A is a schematic drawing illustrating an image-managing system as an example of a data-managing apparatus according to a first embodiment of the present invention, and FIG. 1B is a block diagram illustrating a storage state of image data.

FIG. 2 is a block diagram of the functional structure of the digital camera shown in FIG. 1A.

FIG. 3 is a block diagram of the functional structure of a personal computer (PC) for restoring and searching image data.

FIG. 4 is a block diagram of an example hardware structure of the digital camera shown in FIG. 1A.

FIG. 5 is a block diagram of an example hardware structure of the PC shown in FIG. 3.

FIG. 6 is a flowchart of an operation of the PC shown in FIG. 3, upon receiving image data and voice data from the digital camera shown in FIG. 1A.

FIG. 7 is a flowchart illustrating a process flow when an operator searches an image on the PC of FIG. 3.

FIG. 8 illustrates an example situation in which an operator captures a picture with the digital camera of FIG. 1A and adds a voice memo to the picture.

FIG. 9 illustrates example voice recognition results added to respective image data according to the first embodiment.

FIG. 10 illustrates an example graphic user interface used for searching for an image according to the first embodiment.

FIG. 11 illustrates an example display of a thumbnail of images as a result of an image-searching processing according to the first embodiment.

FIG. 12 illustrates a graphic interface used in searching for an image according to an alternative embodiment.

FIG. 13 illustrates a graphic interface used in searching for an image according to yet another alternative embodiment.

FIG. 14 illustrates a storage state of image data according to a second embodiment.

FIG. 15 is a flowchart illustrating a voice-data adding-processing performed in the digital camera according to the second embodiment.

### DESCRIPTION OF THE EMBODIMENTS

Embodiments of the present invention will be described in detail with reference to the attached drawings.

### First Embodiment

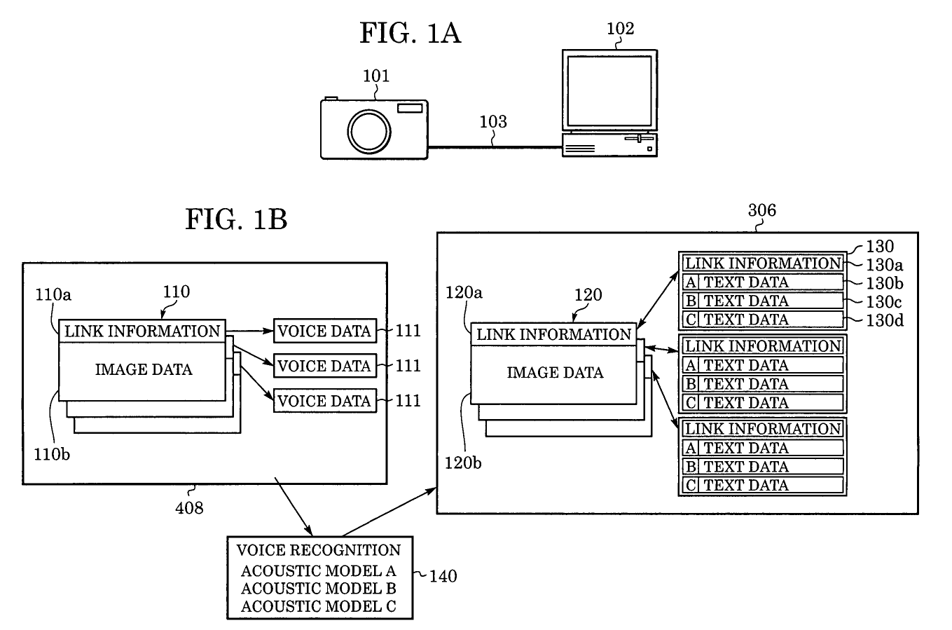

In the present embodiment, an image-managing system for managing images captured by a digital camera will be described as an example of a data-managing apparatus. Referring first to FIGS. 1, 4, and 5, the hardware structure of the image-managing system according to the present embodiment will be described. In the present embodiment, as shown in FIG. 1A, an image captured by a digital camera is uploaded to a personal computer (PC), and the image is searched on the PC with the aid of a voice annotation serving as an identifier. As shown in FIG. 1A, a digital camera 101 uploads an image to a PC 102 via an interface cable (e.g., a USB cable) 103.

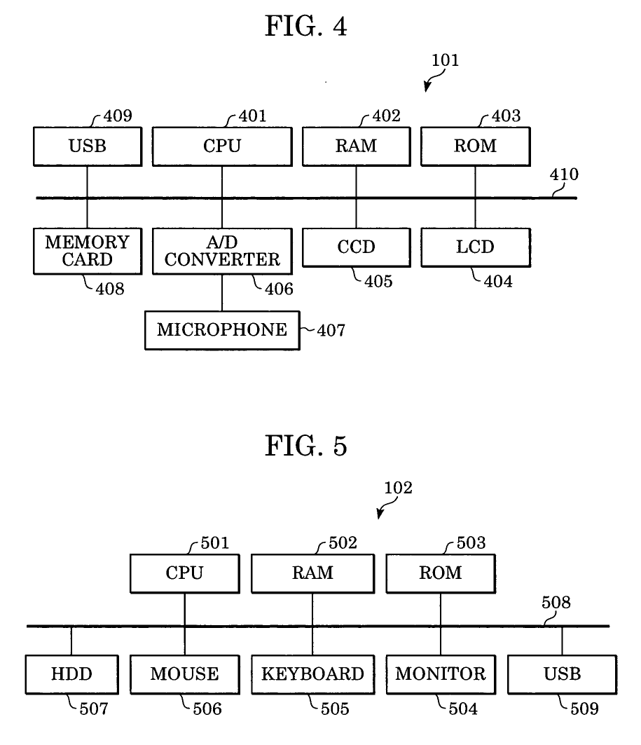

FIG. 4 illustrates an example hardware structure of the digital camera 101 according to the present embodiment. In the structure shown in FIG. 4, by executing control programs stored in a read only memory (ROM) 403, a central processing unit (CPU) 401 executes a variety of operations of the digital camera 101. A random access memory (RAM) 402 provides a memory area necessary for the CPU 401 to execute the program. A liquid crystal display (LCD) 404 includes a liquid crystal panel (i) serving as a finder for displaying an image captured by a charge-coupled device (CCD) 405 in real time at the time of capturing an image and (ii) displaying the captured image.

An analog/digital (A/D) converter 406 converts a voice signal inputted from a microphone 407 into a digital signal. A memory card 408 is used for holding the captured image and voice data. A USB interface 409 is used for transferring the image and the voice data to the PC 102. A bus 410 connects the foregoing components with each other. While the USB used here is an example interface for transferring data, another interface in conformity with other standards may be used.

FIG. 5 illustrates an example hardware structure of the PC 102 according to the present embodiment. In the structure shown in FIG. 5, a CPU 501 executes a variety of processings in accordance with control programs stored in a ROM 503 and loaded from a hard disk 507 to a RAM 502. The RAM 502 provides a memory area necessary for the CPU 501 to execute the variety of processings, in addition to storing the loaded control programs. The ROM 503 holds programs and the like. A monitor 504 displays a variety of items under control of the CPU 501. A keyboard 505 and a mouse 506 constitute an input apparatus with which an operator inputs a variety of items to the PC 102. The hard disk 507 stores image and voice data transferred from the digital camera 101 and a variety of control programs. A bus 508 connects the foregoing components to one another. A USB interface 509 facilitates data communication with the USB interface 409 of the digital camera 101. Meanwhile, it will be understood that, while the USB used here is an example interface for transferring data, another interface in conformity with other standards may be used.

Referring next to FIGS. 1A-B, 2, and 3, general functions and general operations of the image-managing system according to the present embodiment will be described.

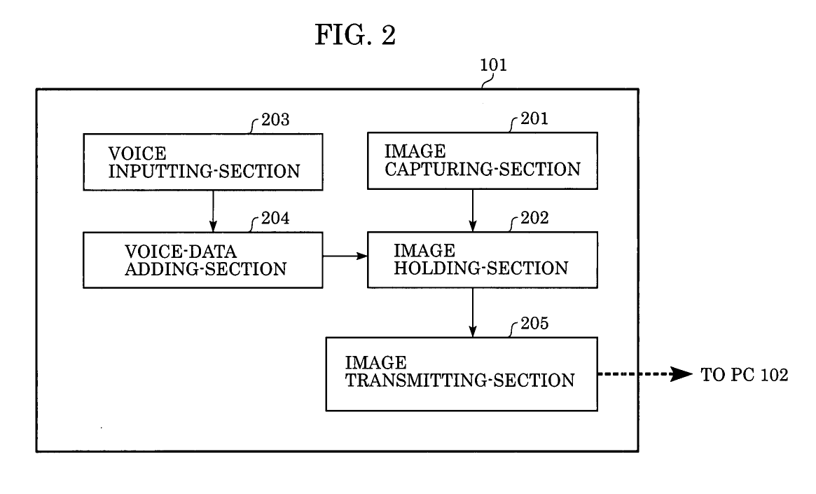

FIG. 2 is a block diagram of example functional structures of the digital camera 101 according to the present embodiment. Each function shown in FIG. 2 is achieved by executing with the CPU 401 the control programs stored in the ROM 403. In the structure shown in FIG. 2, an image capturing-section 201 executes capturing an image with the aid of the CCD 405. An image holding-section 202 stores the image data captured by the image capturing-section 201 in the memory card 408. A voice inputting-section 203 controls inputting of voice data via the microphone 407 and the A/D converter 406. A voice-data adding-section 204 adds voice data obtained from the voice inputting-section 203 to the image data stored in the image holding-section 202. The voice data is also stored in the memory card 408. Also, an image transmitting-section 205 transmits the image data stored in the memory card 408 by the image holding-section 202 to the PC 102 via the USB interface 409, together with the voice data added to the same.

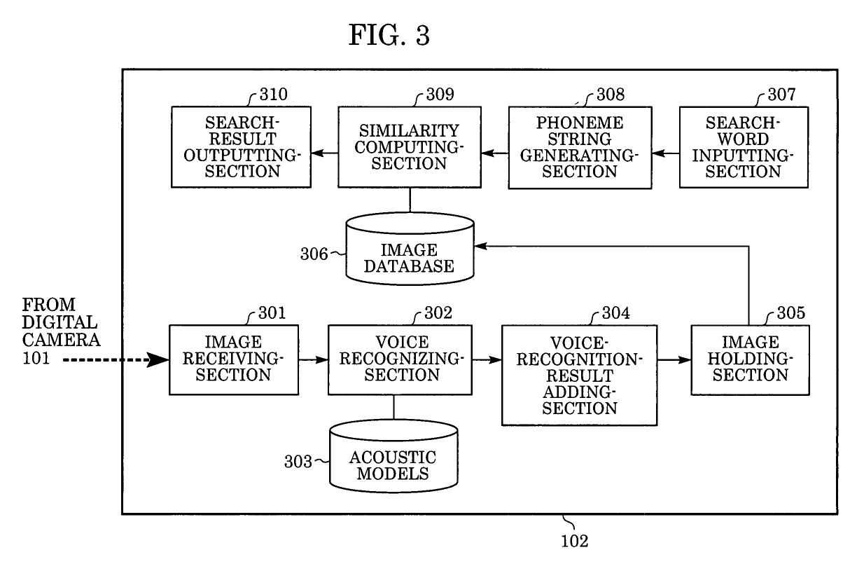

FIG. 3 is a block diagram of example functional structures of the PC 102 according to the present embodiment. Each function shown in FIG. 3 is achieved by executing with the CPU 501 a predetermined control program.

In the structure shown in FIG. 3, an image receiving-section 301 receives the image data and the corresponding voice data from the digital camera 101. A voice recognizing-section 302 recognizes the voice data added to the image data with the aid of acoustic models 303 and converts it into character-row data. The different types of acoustic models 303 can correspond to a plurality of kinds of environments, for example. The voice recognizing-section 302 executes voice recognition with the aid of the different types of acoustic models and obtains recognition results (pieces of character-row data). A voice-recognition-result adding-section 304 links the pieces of character-row data outputted from the voice recognizing-section 302 to the image data having the corresponding voice data added thereto. An image holding-section 305 stores the received image data in an image database 306 in a linked manner to the character-row data serving as the voice recognition results. These aspects will be described in detail with reference to FIG. 1B. In the present embodiment, the image database 306 is provided in the hard disk 507.

A search-word inputting-section 307 provides a predetermined user-interface on the monitor 504 so that an operator can input via the keyboard 505 a search word and a voice-inputting condition. A phoneme string generating-section 308 converts the search-word character-row inputted in the search-word inputting-section 307 into phoneme string. A similarity computing section 309 checks for a match between the one among the character-row data (serving as voice recognition results added to the respective images, corresponding to the specified voice-inputting condition) and the phoneme string generated in the phoneme string generating-section 308 and computes the level of similarity between them. A search-result outputting-section 310 permutes and displays the image data in decreasing order of the levels of coincidence computed by the similarity computing section 309.

General operations for managing image data and voice data of the digital camera 101 and the PC 102 according to the present embodiment will be described with reference to FIG. 1B.

The digital camera 101 adds voice data 111 to respective image data 110b with the aid of the voice-data adding-section 204. With the aid of the image holding-section 202, the memory card 408 stores image data files 110 and corresponding voice data files 111. Each image data file 110 has a header portion 110a including link information for linking the voice data file 111 and the corresponding image data 110b to each other. Various methods for adding voice data to the digital camera 101 have been made, for example:

Voice-Data Adding-Method 1

While pressing a shutter button after capturing an image, a period during pressing of the shutter button is provided as a voice-inputting period so that voice information inputted from the microphone 407 is linked to the image.

Voice-Data Adding-Method 2

In a state in which image data which will have voice data added thereto is displayed on the liquid crystal display 404, the voice data is inputted in accordance with a predetermined operation, and the voice information is linked to the image data.

When the image data file 110 having such voice data added thereto is uploaded to the PC 102 with the image transmitting-section 205, based on the header portion 110a of the inputted image data file 110, the PC 102 recognizes the fact that the voice data (the voice data file 111) is added to the corresponding image data file 110, activates voice-recognition processings 140 in the voice recognizing-section 302, and performs voice recognition of the voice data added to the image data file 110. On this occasion, a plurality of recognition results is obtained with the aid of a plurality of the respective acoustic models 303 and is stored as character-row data 130 linked to the used acoustic models. The character-row data 130 includes text data 130b to 130d of the recognition results obtained with the aid of the corresponding acoustic models. In the present embodiment, the character-row data 130 related to the image data 110b of the image data file 110 is registered in the image database 306 of the PC 102 in a mutually linked manner.

With the aid of the image database 306 having the structure as described above, the search-word inputting-section 307, the phoneme string generating-section 308, the similarity computing section 309, and the search-result outputting-section 310 search for the specific image. In this image-searching processing, when a voice-inputting condition instructed by an operator corresponds to, for example, an acoustic model A, the text data 130b obtained with the aid of the acoustic model A is extracted from the corresponding character-row data 130. Also, the level of similarity between the extracted text data and the inputted query string is computed. Then, the corresponding image data is specified from the searched text data with the aid of link information 130a and presented to an operator.

The method for adding voice data to an image file in the digital camera 101 is not limited as described above. For example, a method of combining the image data and the corresponding voice data so as to be treated as a single image file and link information is managed in an independent file. Also, linking of an image file to the corresponding text data in the PC 102 may be arranged such that a single image file includes both image data and text data or that link information is managed in an independent file.

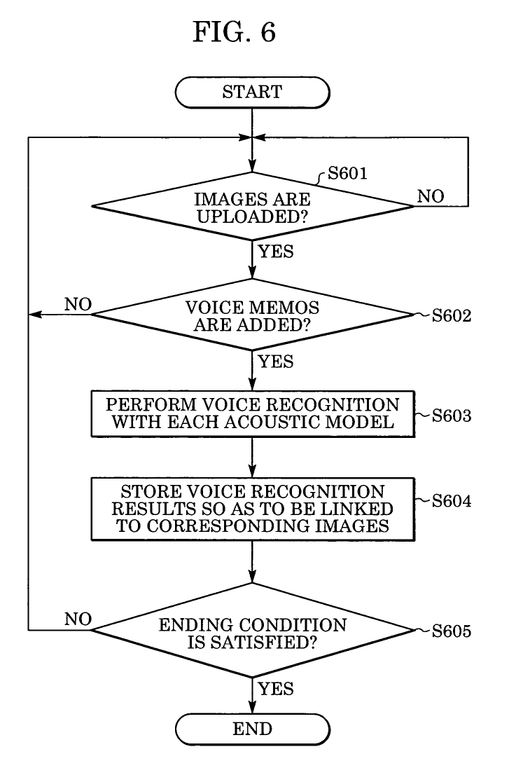

Referring next to a flowchart shown in FIG. 6, an operation of the PC 102 upon receiving image data and voice data from the digital camera will be described. It is presumed that an operator captures at least one image with the aid of the digital camera 101 and inputs some kind of voice memo to all or a part of the captured images, resulting in adding the voice data to the corresponding images. For example, as shown in FIG. 8, when the operator captures an image of a birthday cake and speaks “birthday cake” into the microphone 407 of the digital camera 101, the voice data is added to the captured image of the birthday cake. The image captured as described above and the corresponding voice data are stored in the memory card 408 as described with reference to FIG. 1B. By connecting the digital camera 101 to the PC 102 with the USB cable and performing a predetermined operation, the operator can transfer (upload) the captured images and the corresponding voice data to the PC 102.

In the PC 102, it is determined in step S601 whether images have been transferred (uploaded) from the digital camera 101. If the images have been uploaded, it is determined in step S602 whether voice data (a voice memo) has been added to each image. For example, when the PC 102 has the file structure as shown in FIG. 1B, the above determination can be performed by determining whether each image file has link information on its header portion. If the image data has the corresponding voice data added thereto, the process moves to step S603 where the voice recognizing-section 302 recognizes the voice data with the aid of the corresponding acoustic models 303 and converts the voice data into text data. There are multiple acoustic models 303 corresponding to a plurality of noise environments. For example, in the present embodiment, three “an exhibition-hall acoustic-model,” and “an in-house acoustic model” are provided.

The acoustic models as described above can be produced with known techniques. For example, the exhibition-hall acoustic-model is produced by collecting voices produced in an exhibition hall and applying a predetermined processing on the collected voice data. In general, in the case of recognizing produced voices, use of an acoustic model corresponding to an environment similar to that in which the collected voices are produced provides a higher possibility of an excellent voice recognition feature. For example, in the case of recognizing voices produced in an exhibition hall, use of the exhibition-hall acoustic-model for recognizing the produced voices results in higher accuracy.

In the voice recognizing-section 302, it cannot be known what environment the voice data added to the image data is produced. Hence, in step S603, the voice recognizing-section 302 recognizes the voice data with the aid of each of the acoustic models 303. When the foregoing three acoustic models are provided, three voice recognition results are generated with the aid of the respective models. As described with reference to FIG. 1B, in step S604, these voice recognition results are stored in the image database 306 and linked to the corresponding images. Determination is made whether a predetermined ending condition such as completion of uploading is satisfied, and if not satisfied, the process returns to step S601.

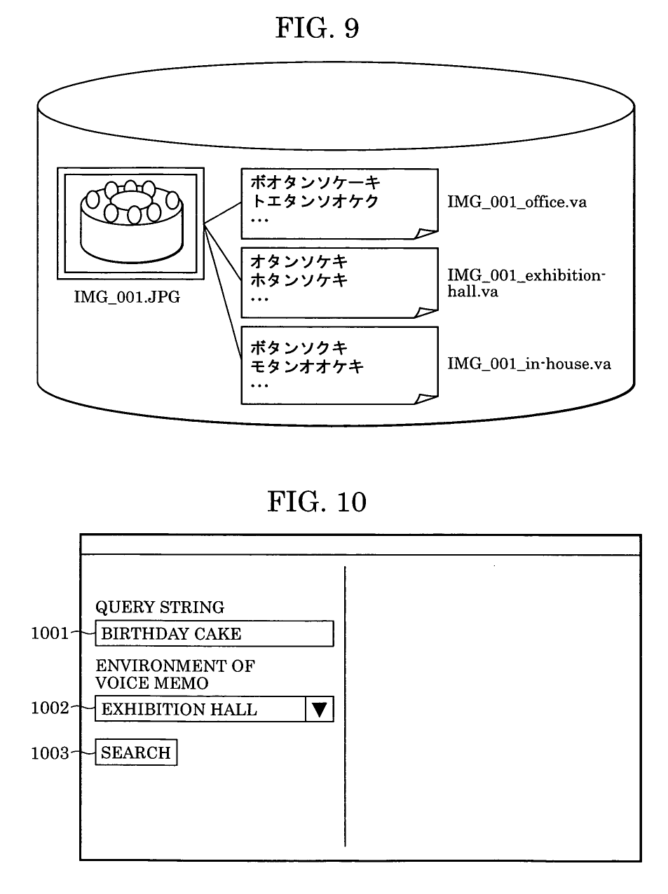

FIG. 9 illustrates example voice recognition results added to a single image. Three voice-recognition result files composed of an IMG_{—}001_office.va file, an IMG_{—}001_exhibition-hall.va file, and an IMG_{—}001_in-house.va file are stored in a linked manner to an image file IMG_{—}001.JPG. Each result file includes character-row data as the voice recognition result obtained with the corresponding one of the office acoustic-model, the exhibition-hall acoustic-model, and the in-house acoustic model. Since voice recognition can generally provide a plurality of solutions, each voice-recognition-result file includes a plurality of voice-recognition-result character-row files.

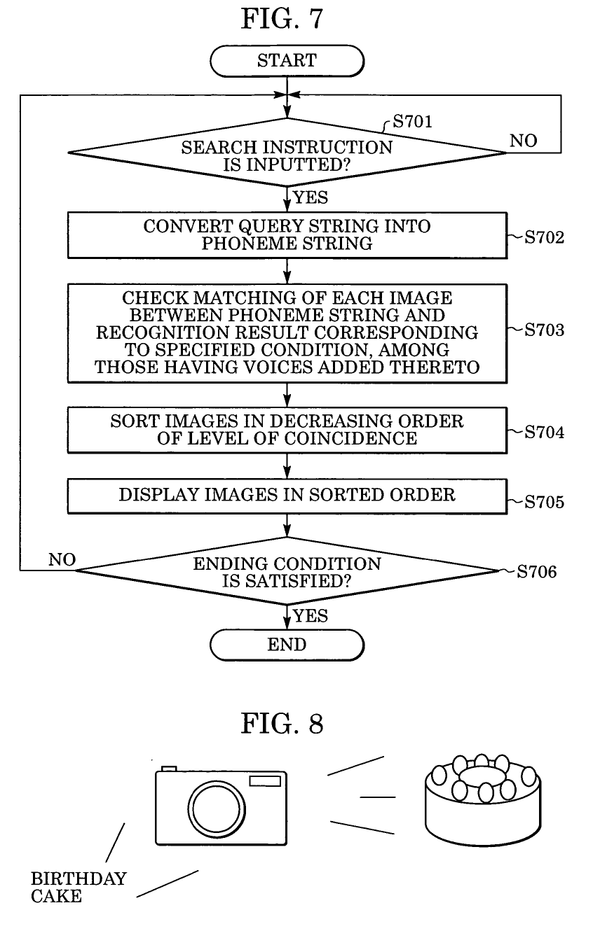

Subsequently, a flow of a searching process of an operator upon searching for an image on the PC 102 will be described with reference to a flowchart illustrated in FIG. 7. With an application for searching for an image, a part of the functional structures 307 to 310 shown in FIG. 3 are achieved. The search-word inputting-section 307 provides a user interface as shown in FIG. 10. An operator inputs a query string into a query string input field 1001, selects an environment with a pulldown menu 1002, in which the corresponding voice is collected, and then executes a search of the image by clicking a search button 1003 (step S701).

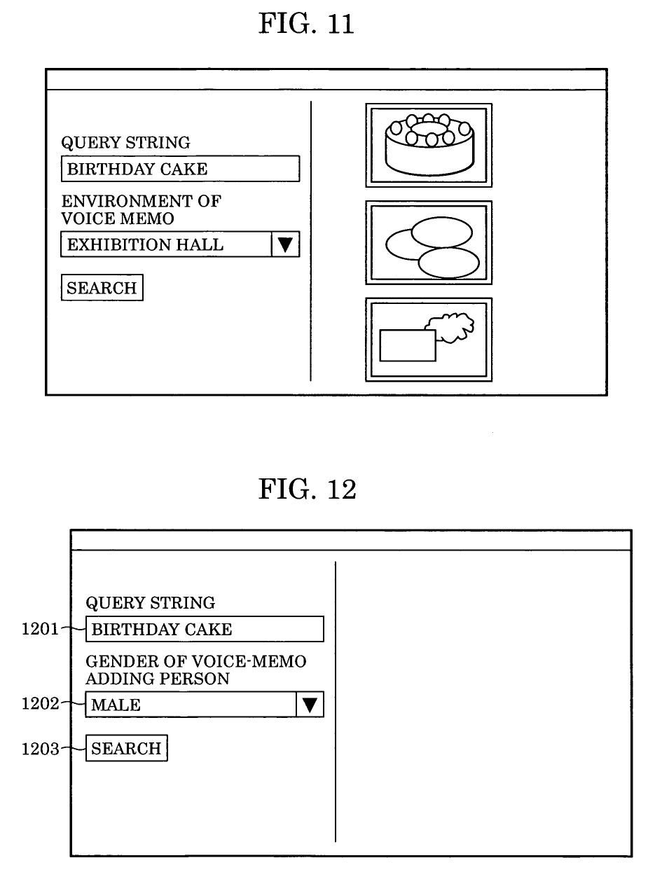

Upon receiving a search instruction from the operator, the process moves from step S701 to step S702, and the phoneme string generating-section 308 converts the query string inputted in the field 1001 into a phoneme string. Conversion of the query string into the phoneme string can be achieved by making use of the known natural language processing techniques. For example, when an operator inputs a query string “birthday cake,” the string is converted into the phoneme string “B ER TH D EY K EY K”. Subsequently, in step S703, the similarity computing section 309 computes the level of similarity between the character-row data (voice recognition results) linked to all images stored in the image database 306 and the phoneme string. As described above with reference to FIG. 9, a plurality of voice recognition results corresponding to a plurality of acoustic models is added to a single image. In order to compute the level of similarity, the similarity computing section 309 uses only one of these voice recognition results that corresponds to the acoustic model in agreement with the voice-inputting condition specified by the pulldown menu 1002, because the voice recognition result obtained with the aid of the acoustic model in agreement with the voice-inputting condition has a high possibility of higher accuracy than those obtained with the aid of the other acoustic models. For example, in the case where an operator specifies “exhibition hall” as shown in FIG. 10, by using the IMG_{—}001_exhibition-hall.va file shown in FIG. 9, the matching between the query string written in the file and the query string “birthday cake” is checked and the level of the coincidence is computed. The computation of the level of similarity can be carried out with the aid of known methods such as the DP matching method. In step S704, on the basis of the computed results of the foregoing levels of coincidence of all image data conducted by the search-result outputting-section 310, the images are sorted in decreasing order of the levels of coincidence and the images are displayed in that order as the search result in step S705. FIG. 11 is an example display of the search result.

As described above, a voice recognition processing taking into account environmental noise at the time of inputting a voice and a search based on this voice recognition can be performed, thereby resulting in an accurate and effective search.

Modifications of First Embodiment

In the foregoing embodiment, acoustic models corresponding to respective noise environments are used, and one of the noise environments is specified upon performing a search. Instead of noise environments, a gender of a speaker can also be used as a voice-adding condition. For example, male and female models are prepared as acoustic models, and upon performing voice recognition, all results of voice data recognized with the corresponding acoustic models are added to an image. Upon performing a search, as shown in FIG. 12, a gender of a memo-adding person is selected with a pulldown menu, and the level of similarity of the search is computed by making use of the voice recognition result obtained with the aid of the acoustic model in agreement with the selection.

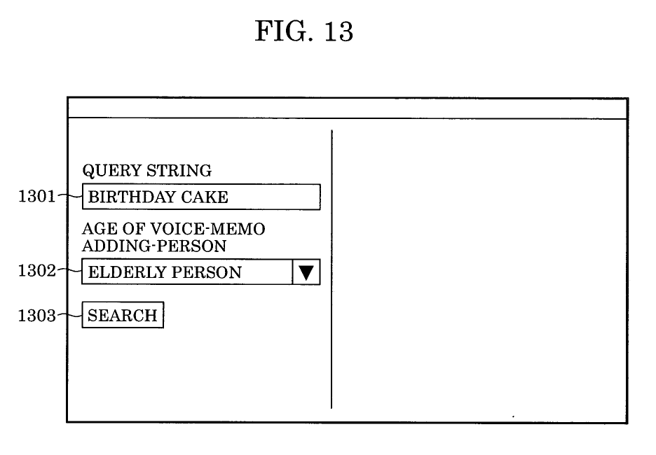

Alternatively, acoustic models for age groups of speakers may be prepared. In this case, for example, a child model, an adult model, and an elderly person model are prepared as acoustic models. Upon performing voice recognition, all results of voice data recognized with the corresponding acoustic models are added to the corresponding image. Upon performing a search, as shown in FIG. 13, an age-category of a voice-memo adding-person is selected with a pulldown menu, and the level of similarity of the search is computed by making use of the voice recognition result obtained with the aid of the acoustic model in agreement with the selection.

While a voice adding-condition inputted upon searching for an image and an acoustic model have a one-to-one correspondence in the foregoing embodiment, these may have another corresponding relationship. For example, the image-managing system may be arranged such that four kinds of acoustic models: an office model, an in-house model, an exhibition hall model, and an urban-district acoustic model are used for performing voice recognition. Upon performing a search, either “indoor” or “outdoor” is selected as a voice-annotation adding-condition. When “indoor” is selected by an operator upon performing a matching processing of the search, the voice recognition results obtained with the aid of the respective two acoustic models “office and “in-house” are used. When “outdoor” is selected, the voice recognition results obtained with the aid of the respective two acoustic models “exhibition hall” and “urban district” are used.

As described above, according to the first embodiment, the voice recognition result obtained with the aid of an acoustic model best suited for an environment of a voice input can be used, thereby achieving an accurate search. In addition, the PC 102 can be engaged in a plurality of voice-inputting conditions, whereby the digital camera 101 can be engaged exclusively in capturing an image and inputting a voice, thereby resulting in a user-friendly system.

### Second Embodiment

According to the first embodiment, in the PC 102, by applying various voice-recognition processings (various acoustic models), a number of recognition results is obtained. These recognition results are stored in a linked manner to the corresponding image, the recognition results corresponding to voice-inputting conditions specified as search conditions are extracted, and a search is performed on the basis of a query string, within the scope of the extracted recognition results. Unfortunately, in this case, an operator must bear voice-inputting conditions in mind, in accordance with which a voice linked to a searching image is inputted. According to a second embodiment, in the digital camera 101, upon registering voice data linked to image data, the voice data has information representing a voice-inputting condition included therein. For example, the voice data has a voice-inputting condition serving as a piece of attribute information of the voice data included therein.

FIGS. 1A, 4, and 5 illustrate the structure of an image-managing system according to the second embodiment. While the digital camera 101 has substantially the same functional structure as that of the first embodiment (see FIG. 2), the voice-data adding-section 204 arranges attribute information set by an operator and representing a voice-inputting condition so as to be included in voice data. Also, while the PC 102 has substantially the same functional structure as that of the first embodiment (see FIG. 3), the voice recognizing-section 302 performs voice recognition with the aid of an acoustic model best suited for the voice-inputting condition represented by the attribute information of the voice data. The environment of a voice memo specified at the time of searching for an image is not needed to be set (with the aid of the pulldown menu 1002 shown in FIG. 10). According to the first embodiment, the similarity computing section 309 uses only the voice recognition result corresponding to the acoustic model in agreement with the voice-inputting condition specified with the pulldown menu 1002, for computing the level of similarity. Whereas, according to the second embodiment, all voice recognition results are used without such a distinction.

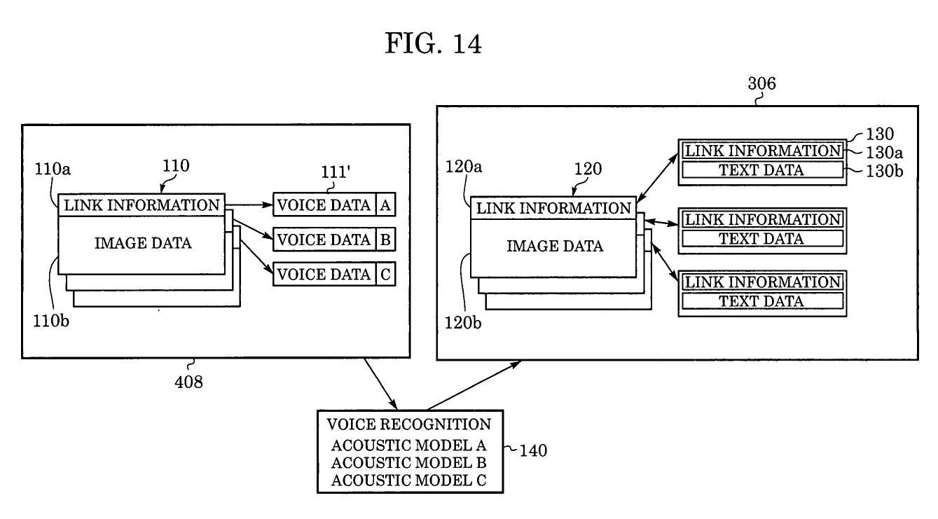

FIG. 14 illustrates a method for managing image data and voice data according to the second embodiment. In comparison to FIG. 1B, a difference from the first embodiment lies in that voice data stored in the memory card 408 has attribute information added thereto, representing the corresponding voice-inputting condition. The character-row data 130 stored in the PC 102 includes only the recognition result as the text data 130b, obtained with the aid of an acoustic model corresponding to the voice-inputting condition represented by attribute information of the voice data.

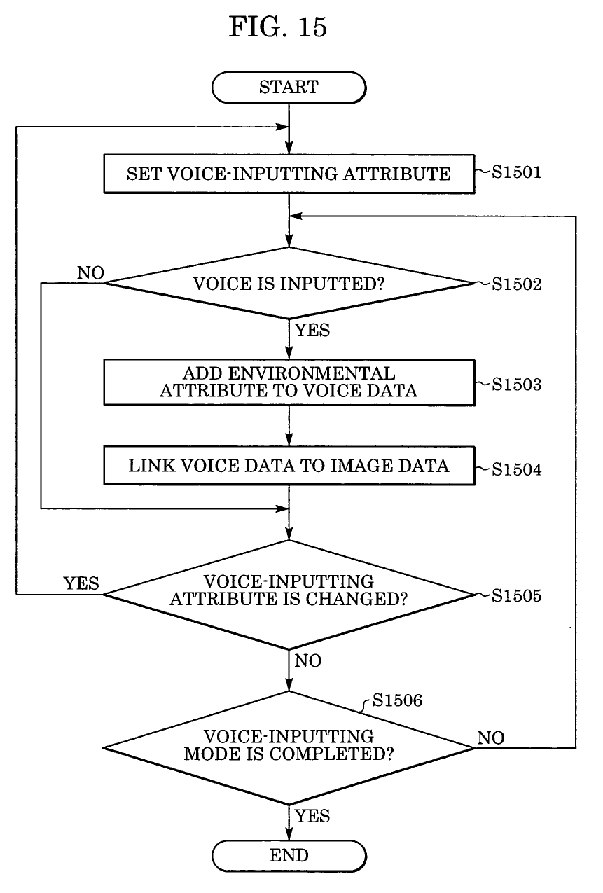

FIG. 15 is a flowchart of a processing of linking voice data to image data performed in the digital camera 101 according to the second embodiment.

In the digital camera 101, upon receiving an instruction of a voice-inputting mode via a predetermined user-interface, the corresponding voice-inputting condition is specified in step S1501. The voice-inputting condition can be set, for example, among office, exhibition hall, and in-house conditions. When a voice is inputted in accordance with the foregoing voice-data adding-methods 1 or 2, the process moves from step S1502 to step S1503, and the attribute information set in step S1501 and representing the corresponding voice-inputting condition is added to the voice data obtained via the microphone 407 and the A/D converter 406. In step S1504, the voice data is stored in the memory card 408 in a linked manner to the corresponding image data. As described above, the voice data having the corresponding attribute information added thereto and representing its voice-inputting condition is stored in the memory card 408 in a linked manner to the corresponding image data.

When an operation is made so as to change the voice-inputting condition to another one, the process returns from step S1505 to step S1501. Upon receiving an instruction of completing the voice-inputting mode, the process ends through step S1506.

An operation of the PC 102 to which the image data and the voice data linked to the image data as described above are uploaded will be described by making use of the flowcharts illustrated in FIGS. 6 and 7 according to the first embodiment.

First, the operation for receiving the image data and the voice data will be described with reference to FIG. 6. A difference from the first embodiment lies in that an acoustic model to be used for performing voice recognition is determined in steps S603 and S604 on the basis of the attribute information (the voice-inputting condition) added to the voice data, and the recognition result obtained with the aid of the determined acoustic model is stored in a linked manner to the corresponding image data. For example, when the voice-inputting condition is “exhibition hall”, among previously prepared an “office acoustic-model”, an “exhibition-hall acoustic-model”, and an “in-house acoustic model”, the “exhibition-hall acoustic-model” is selected so as to perform the voice recognition, and the query string as the result of the voice recognition is registered in the image database 306 in a linked manner to the corresponding image data.

Next, the operation for searching for the image data will be described with reference to FIG. 7. A difference from the first embodiment lies in that only the query string is set without setting the voice-inputting condition as the search condition. In step S703, the matching between the searching image data and each of all character-row data registered in the image database 306 is checked.

As described above, according to the second embodiment, the voice recognition result obtained with the aid of the acoustic model best suited for an environment of inputting a voice can be used, thereby achieving an accurate search. In addition, since the digital camera is capable of setting a voice-inputting environment, the trouble of setting the voice-inputting condition upon performing a search is saved, thereby resulting in a user-friendly system.

One skilled in the art will appreciate that the variations of the voice-inputting condition as described in the modification of the first embodiment are also applicable to the second embodiment. Also, the image-managing system may be arranged such that a plurality of voice-inputting conditions is set in the voice data in the digital camera 101 and a plurality of recognition results corresponding to the plurality of set voice-inputting conditions is stored in the PC 102. In the second embodiment, all recognition results stored as described above are objects to be searched.

Although managing image data has been described in the above-described embodiments, the present invention is not limited only to managing the image data. This invention applicable to managing text data, audio data, and so on.

While the image-managing system is achieved by executing predetermined software with the aid of the CPU in the first and second embodiments, the system is not limited to such a structure and it may be achieved with a hardware circuit performing a similar operation to the CPU.

The present invention may be applicable to a system composed of a plurality of components or a single component. It will be understood that the system is also achieved by supplying a recording medium storing a program code of the software for achieving the functions of the foregoing embodiment to the system or the data-managing apparatus and by reading the program code stored in the recording medium with the aid of a computer (alternatively, a CPU or a MPU) of the system or the apparatus so as to execute it. In this case, the program code itself read from the recording medium achieves the functions of the foregoing embodiments, whereby the recording medium storing the program code constitutes the present invention.

As the recording medium for supplying the program code, for example, a floppy disk, a hard disk, an optical disk, a magneto-optical disk, a CD-ROM, a CD-R, a magnetic tape, a nonvolatile memory card, a ROM, or the like can be used.

Those skilled in the art will appreciate that the present invention includes not only a case where the functions of the foregoing embodiments are achieved by executing the program code read by the computer but also another case where the functions of the foregoing embodiments are achieved by carrying out a part of or all of actual processings with the aid of an operating software (OS) running on the computer in accordance with the instruction of the program code.

One skilled in the art will appreciate that the present invention also includes another case where, after the program code read from the recording medium is written in a memory included in a functional extended board inserted in the computer or a functional extended unit connected to the computer, by carrying out a part of or all of the actual processings with the aid of the functional extended board or a CPU included in the functional unit in accordance with the instruction of the program code, the functions of the foregoing embodiments are achieved.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-263070 filed Aug. 13th, 2004, which is hereby incorporated by reference herein in its entirety.

What is claimed is:

1. A data-managing method comprising the steps of:
receiving data and corresponding linked voice data;
recognizing the voice data with voice-recognition processings to obtain voice recognition results; and
storing the data and the voice recognition results in a linked manner.

2. The data-managing method according to claim 1, further comprising the steps of:
receiving a search condition including a keyword and corresponding-information corresponding to the voice-recognition processings; and
comparing the keyword and the voice-recognition results recognized with the voice-recognition processings corresponding to the corresponding-information to obtain a search result by.

3. The data-managing method according to claim 1, wherein the recognizing step includes recognizing the voice data with a plurality of acoustic models.

4. The data-managing method according to claim 3, wherein the plurality of acoustic models corresponds to a plurality of noise environments.

5. The data-managing method according to claim 3, wherein the plurality of acoustic models corresponds to a plurality of speakers' conditions.

6. A control program enabling a computer to execute the data-managing method according to claim 1.

7. A control program enabling a computer to execute the data-managing method according to claim 2.

8. A control program enabling a computer to execute the data-managing method according to claim 3.

9. A control program enabling a computer to execute the data-managing method according to claim 4.

10. A control program enabling a computer to execute the data-managing method according to claim 5.

11. A data-managing apparatus, comprising:
a receiving device configured to receive data and corresponding linked voice data;
a voice recognition unit configured to apply voice-recognition processings on the voice data to obtain voice recognition results; and
a storing device configured to store the data and the voice recognition results in a mutually linked manner.
